(19) United States
(12) Patent Application Publication
(10) Pub. No.: US 2025/0087983 A1
(43) Pub. Date: Mar. 13, 2025

(54) SUSPENSION WIRING MODULE

(71) Applicant: SUMITOMO WIRING SYSTEMS, LTD., Mie (JP)

(72) Inventors: Naofumi YAMATAKE, Mie (JP); Takahiro MURATA, Mie (JP)

(21) Appl. No.: 18/726,826

(22) PCT Filed: Jan. 5, 2023
(86) PCT No.: PCT/JP2023/000086

§ 371 Date: Jul. 5, 2024

(30) Foreign Application Priority Data
Jan. 12, 2022 (JP) 2022-002791

(51) Int. Cl. H02G 11/00; B60R 16/02

(52) U.S. Cl. CPC H02G 11/00; B60R 16/0215

(57) ABSTRACT

A suspension wiring module includes a wiring member for connecting a vehicle body-side device and a wheel-side device, and a part in an extension direction of the wiring member is fixed in a rotation stopped state at a rotation stopping/fixing position on a steering rotation center axis.

### TECHNICAL FIELD

The present disclosure relates to a suspension wiring module.

### BACKGROUND

Patent Document 1 discloses a wiring device for supplying an electrical signal from a vehicle body to an in-wheel motor. In Patent Document 1, it is disclosed that a wiring has to follow the turning of a tire caused by turning a steering wheel and, to that end, is provided with a slight slack.

### PRIOR ART DOCUMENT

### Patent Document

Patent Document 1: JP 2005-271909 A

### SUMMARY OF THE INVENTION

### Problems to be Solved

A suspension wiring member is deformed by a steering operation and a vertical movement of the tire. It is desired to make the behavior of the suspension wiring member as simple as possible.

Accordingly, the present disclosure aims to simplify the behavior of a suspension wiring member.

### Means to Solve the Problem

The present disclosure is directed to a suspension wiring module with a wiring member for connecting a vehicle body-side device and a wheel-side device, a part in an extension direction of the wiring member being fixed in a rotation stopped state at a rotation stopping/fixing position on a steering rotation center axis.

### Effect of the Invention

According to the present disclosure, the behavior of a suspension wiring member can be simplified.

### BRIEF DESCRIPTION OF THE DRAWINGS

FIG. 1 is a schematic section showing a suspension wiring module.

FIG. 2 is a schematic section along II-II in FIG. 1.

FIG. 3 is an enlarged view of FIG. 2.

FIG. 4 is a diagram showing a suspension wiring module according to a first modification.

FIG. 5 is a diagram showing a suspension wiring module according to a second modification.

FIG. 6 is a diagram showing a suspension wiring module according to a third modification.

FIG. 7 is a diagram showing a suspension wiring module according to a fourth modification.

FIG. 8 is a diagram showing a suspension wiring module according to a fifth modification.

### DETAILED DESCRIPTION TO EXECUTE THE INVENTION

### Description of Embodiments of Present Disclosure

First, embodiments of the present disclosure are described.

The suspension wiring module of the present disclosure is as follows.
(1) The suspension wiring module is provided with a wiring member for connecting a vehicle body-side device and a wheel-side device, a part in an extension direction of the wiring member being fixed in a rotation stopped state at a rotation stopping/fixing position on a steering rotation center axis.

According to the present disclosure, the deformation of the wiring member due to a steering operation mainly occurs on a side closer to the wheel-side device than the rotation stopping/fixing position and hardly occurs on a side closer to the vehicle body-side device than the rotation stopping/fixing position. Thus, the behavior of the suspension wiring module can be simplified with the rotation stopping/fixing position as a boundary.
(2) In the suspension wiring module of (1), the wiring member may be fixed at a position different from an extension of a damper. In this way, the behavior of the suspension wiring member can be simplified in a configuration in which the extension of the damper and the steering rotation center axis are present at different positions.
(3) In the suspension wiring module of (1) or (2), the wiring member may include a first linear transmission member and a second linear transmission member, and a length of the first linear transmission member from the rotation stopping/fixing position to the wheel-side device may be equal to a length of the second linear transmission member from the rotation stopping/fixing position to the wheel-side device. In this way, behavioral variations of the first and second linear transmission members can be suppressed.
(4) In the suspension wiring module of any one of (1) to (3), the wiring member may be fixed by a fixing member fixed to at least one of a damper, an upper arm and a lower arm at the rotation stopping/fixing position. In this way, the wiring member is easily fixed in the rotation stopped state.
(5) In the suspension wiring module of any one of (1) to (4), the wiring member may be so fixed at the rotation stopping/fixing position that an angle of the extension direction of the wiring member to the steering rotation center axis is within a range of ±30°.

In this way, a part of the wiring member closer to a wheel than the rotation stopping/fixing position is easily twisted and deformed.

### Details of Embodiment of Present Disclosure

A specific example of a suspension wiring module of the present disclosure is described below with reference to the drawings. Note that the present disclosure is not limited to these illustrations, but is represented by claims and intended to include all changes in the scope of claims and in the meaning and scope of equivalents.

### Embodiment

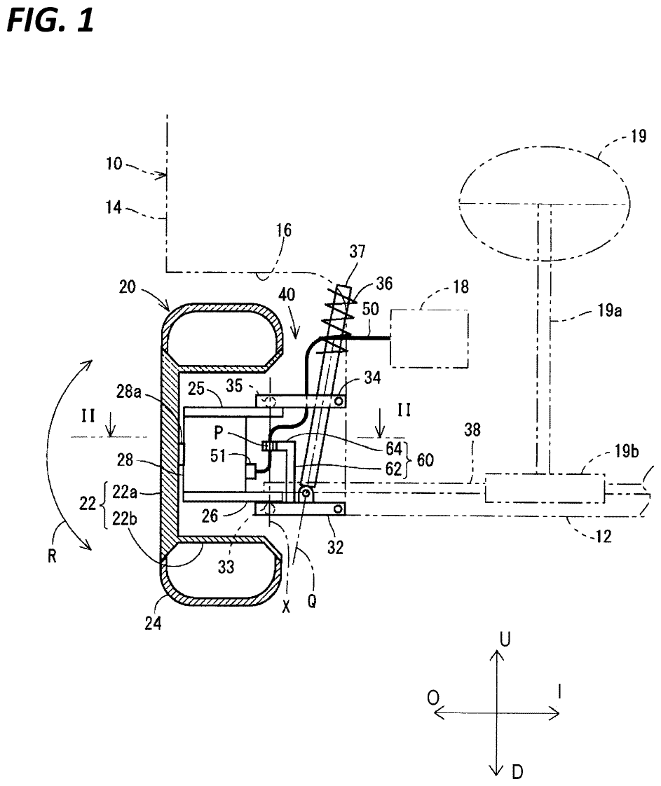

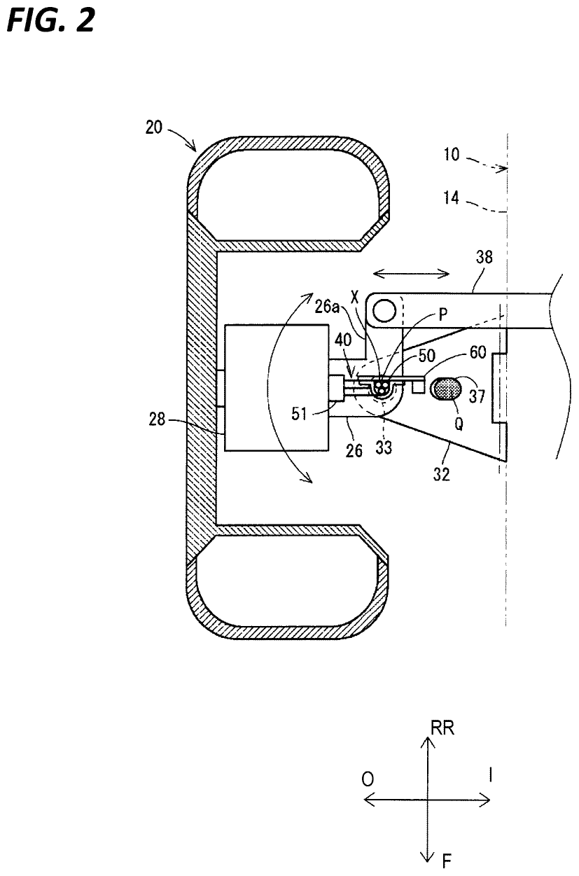

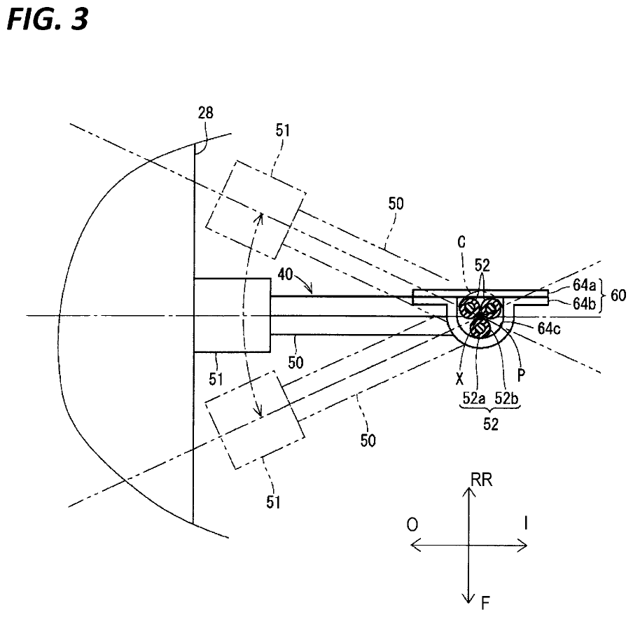

Hereinafter, a suspension wiring module according to an embodiment is described. FIG. 1 is a schematic section showing a suspension wiring module 40. FIG. 1 is a schematic section in a plane orthogonal to a front-rear direction of a vehicle body 10 and passing through a center axis of a wheel 20. FIG. 2 is a schematic section along II-II in FIG. 1. FIG. 2 mainly shows a part around the wheel 20. FIG. 3 is an enlarged view of FIG. 2. FIG. 3 mainly shows a relationship of a steering rotation center axis X, a wiring member 50 and a wheel-side device 28. In each figure, arrows respectively indicating front and rear sides, upper and lower sides, and inner and outer sides are written for the convenience of description. A travel direction when an automotive vehicle normally travels is a forward direction and an opposite direction thereof is a rearward direction. The upper and lower sides are upper and lower sides in a direction of gravity. The inner side is a vehicle central side in a vehicle width direction, and the outer side is a vehicle outer side in the vehicle width direction.

The suspension wiring module 40 is provided with the wiring member 50. The suspension wiring module 40 may be provided with a fixing member 60. The wiring member 50 is a member for wiring for connecting a vehicle body-side device 18 and the wheel-side device 28. The wiring member 50 extends along a wiring path connecting the vehicle body-side device 18 and the wheel-side device 28. The fixing member 60 is a member for fixing a part in an extension direction of the wiring member 50 so that the wiring member 50 is routed along the wiring path.

An example of the vehicle body 10 serving as an assembly target of the suspension wiring module 40 is described. The vehicle body 10 is a vehicle body in a four-wheeled automotive vehicle. FIG. 1 shows a part of the vehicle body 10 around the front wheel 20. The suspension wiring module 40 is assumed to be for the wheel 20 to be steered by a steering operation. For example, the wheel 20 is a front wheel. Note that, in the case of steering a rear wheel, a suspension wiring module may be used for this rear wheel.

The vehicle body 10 is provided with a floor part 12 and a body part 14. The floor part 12 is a part facing the ground. The body part 14 is provided above the floor part 12 and forms the exterior of the vehicle body 10. The vehicle body 10 may be a monocoque body, in which rigid frame and body are integrated, or may be configured such that a body is installed on a frame.

The wheel 20 is rotatably supported in the vehicle body 10. In an example shown in FIG. 1, the wheel 20 is rotatably supported in a fender apron 16. A suspension device may support the wheel 20 by any arbitrary suspension method such as an independent suspension method. In the example shown in FIG. 1, the wheel 20 is shown to be supported by a lower arm 28 and an upper arm 34. The suspension device shown in FIG. 1 is an example of a double wishbone type suspension.

More specifically, the wheel 20 includes a disk wheel 22 and a tire 24. The disk wheel 22 is made of metal such as iron or aluminum. The disk wheel 22 includes a disk portion 22a and a tire mounting portion 22b. The disk portion 22a is formed into a disk shape. The tire mounting portion 22b is an annular part projecting inward in the vehicle width direction from the surrounding of the disk portion 22a. Annular rims project on both side edges of the tire mounting portion 22b. The tire 24 made of a resilient material such as rubber is mounted on the outer periphery of the tire mounting portion 22b.

The wheel 20 is provided with the wheel-side device 28. Here, the wheel-side device 28 is described, assuming that the wheel-side device 28 is an in-wheel motor. Note that the in-wheel motor is a travel motor incorporated into the wheel 20 to rotate the wheel 20. Here, a shaft 28a of the wheel-side device (in-wheel motor) 28 is coupled to a central part of the disk portion 22a with the wheel-side device 28 disposed in the tire mounting portion 22b. In this way, the wheel-side device 28 is integrally incorporated into the wheel 20.

An upper knuckle portion 25 and a lower knuckle portion 26 are mounted on the wheel-side device 28. The upper knuckle portion 25 extends inward in the vehicle width direction from an upper part of the wheel-side device 28. The lower knuckle portion 26 extends inward in the vehicle width direction from a lower part of the wheel-side device 28. An arm portion 26a for receiving a steering force projects from the lower knuckle portion 26. Here, the arm portion 26a extends rearward from an inner side in the vehicle width direction of the lower knuckle portion 26. If the wheel-side device 28 is not the in-wheel motor, the upper and lower knuckle portions 25, 26 may extend inward in the vehicle width direction from bearing portions for rotatably supporting the wheel 20.

The lower and upper arms 32, 34 are members made of metal or the like. Base end parts of the lower and upper arms 32, 34 are located at vertically separated positions in the fender apron 16. The base end parts of the lower and upper arms 32, 34 are supported swingably with respect to the vehicle body 10. Center axes when the base end parts of the lower and upper arms 32, 34 swing are along the front-rear direction of the vehicle body 10. The base end parts of the lower and upper arms 32, 34 may be swingably supported on the floor part obliquely in front of, inside, obliquely behind or behind the wheel. In these cases, axes of rotation when the lower and upper arms swing may be along a lateral direction of the vehicle body, may be along the front-rear direction or may be along a direction oblique to both the lateral direction and front-rear direction.

Tip parts of the lower and upper arms 32, 34 extend outward in the vehicle width direction in the fender apron 16. A bearing portion 33 is provided on the tip part of the lower arm 32. A bearing portion 35 is provided on the tip part of the upper arm 34. The bearing portions 33, 35 may be ball joints.

The lower knuckle portion 26 is rotatably supported on the tip part of the lower arm 32 via the bearing portion 33. The upper knuckle portion 25 is rotatably supported on the tip part of the upper arm 34 via the bearing portion 35. The bearing portion 35 is located above the bearing portion 33. The wheel 20 can turn to laterally swing about an axis of rotation passing through the bearing portions 33, 35. The axis of rotation passing through the bearing portions 33, 35 is a steering rotation center axis X, about which the wheel 20 turns in the fender apron 16.

A spring 36 and a damper 37 are provided between the lower arm 32 and the vehicle body 10. More specifically, an upper end part of the damper 37 is supported on the vehicle body 10 above the wheel 20. The upper arm 34 is formed with an opening, through which the damper 37 can be passed. The damper 37 reaches the lower arm 32 through the opening formed in the upper arm 34. A lower end part of the damper 37 is rotatably coupled to the lower arm 32. An axis of rotation of the damper 37 with respect to the lower arm 32 is along the front-rear direction.

As described above, since the base end parts of the lower and upper arms 32, 34 are swingably supported on the vehicle body 10, the lower and upper arms 32, 34 support the wheel 20 movably in a vertical direction in the fender apron 16. The damper 37 is interposed between the lower arm 32 and the vehicle body 10 with movements of the wheel 20 in the front-rear direction and lateral direction restricted by the lower and upper arms 32, 34. If the wheel 20 vertically moves due to an uneven road surface, the lower and upper arms 32, 34 vertically swing (see arrows R of FIG. 1). According to a swinging motion of the lower arm 32, the damper 37 extends while changing an angle to the lower arm 32. An impact caused by the uneven road surface during travel is absorbed by the extension of the damper 37 and the spring 36 externally mounted on the damper 37 at this time.

In this embodiment, the steering rotation center axis X by the bearing portions 33, 35 is located at a position different from an extension Q of the damper 37. Note that, as described later, the extension of the damper may coincide with the steering rotation center axis X.

A tie rod 38 is coupled to a tip part of the arm portion 26a. If a steering wheel 19 is turned by a steering operation by a driver, that rotational motion is transmitted as a movement in the vehicle width direction to the tie rod 38 via a steering shaft 19a and a transmission mechanism 19b such as a rack and pinion mechanism. If the tie rod 38 moves in the vehicle width direction, the lower knuckle portion 26 can turn about the axis of rotation of the bearing portion 33 (i.e. the steering rotation center axis X). In this way, the wheel 20 can turn about the steering rotation center axis X by the steering operation. By the turning of the wheel 20 about the steering rotation center axis X, an advancing direction of the vehicle body 10 is changed. That is, the steering rotation center axis X may be a center axis when the wheel 20 is turned by an operation to the steering wheel 19. The steering rotation center axis X may be grasped as an axis close to the direction of gravity than a horizontal direction. The steering rotation center axis X may be grasped as a center axis, about which the wheel 20 is turned to change the advancing direction of the vehicle body 10.

The vehicle body-side device 18 is provided on the side of the vehicle body 10, and the wheel-side device 28 is provided on the side of the wheel 20. The wheel-side device 28 is a device incorporated into the wheel 20 and configured to turn about the steering rotation center axis X together with the wheel 20 with respect to the vehicle body 10. As described above, if the wheel-side device 28 is assumed to be the in-wheel motor, the vehicle body-side device 18 is assumed to be a drive unit for driving the in-wheel motor. For example, if the in-wheel motor is a three-phase induction motor, the vehicle body-side device 18 is assumed to be an inverter unit for feeding three-phase alternating currents of U-phase, V-phase and W-phase for driving the in-wheel motor. Note that the vehicle body-side device 18 is a device provided in the vehicle body 10 and configured not to turn even if the wheel 20 turns about the steering rotation center axis X.

The wheel-side device 28 may be a device integrated with the in-wheel motor and the inverter unit for driving the in-wheel motor. In this case, the vehicle body-side device 18 may be a power supply for supplying a direct current to the inverter.

It is not essential that the wheel-side device 28 is the in-wheel motor. Instead of or in addition to the in-wheel motor, the wheel-side device 28 is assumed to be a device provided with a sensor, an electric brake or the like. For example, the sensor may be a sensor for detecting a rotation speed of the wheel or a temperature sensor for detecting a temperature of the in-wheel motor or the like. The wheel-side device 28 may be an electric brake including a motor or the like for braking the rotation of the wheel 20, using electricity as power. The electric brake may be an electric parking brake used when the automotive vehicle is parked or stopped or a brake used during the travel of the automotive vehicle. The vehicle body-side device 18 may be a device for transmitting and receiving signals to and from these wheel-side devices 28 or supplying power thereto. For example, the vehicle body-side device 18 may have a function as an ECU (Electronic Control Unit) for receiving a signal from the sensor and controlling the electric brake. The vehicle body-side device 18 may be provided in the vehicle body 10 or outside the vehicle body 10. Here, the vehicle body-side device 18 is provided in the vehicle body 10.

The wheel-side device 28 may be a device including an ECU. For example, the ECU may control the inverter unit or may control the electric brake.

The wiring member 50 includes at least one linear transmission member for transmitting electricity or light. One end part of the wiring member 50 is connected to the vehicle body-side device 18. The other end part of the wiring member 50 is connected to the wheel-side device 28. Here, the wiring member 50 includes at least one electrical conductor. FIG. 3 shows an example in which the wiring member 50 includes power supply wires as wires 52. The wire 52 is such that a coating 52b is formed around a core wire 52a. The wires 52 are, for example, power supply wires for supplying three-phase alternating currents to the in-wheel motor, and three wires 52 are shown in FIG. 3. The wiring member 50 may include a signal wire for transmitting a signal. For example, a wiring member may include a signal wire for sensor or for control. The signal wire may be a coated wire or an optical fiber cable.

A plurality of (here, three) wires 52 are collected into one. A configuration for collecting the plurality of wires 52 into one is any configuration. For example, the plurality of wires 52 may be collected into one by a bracket for supporting the wiring member 50 at a fixed position. The bracket here may be the fixing member 60.

The plurality of wires 52 may be collected into one by a protective member. The protective member may be, for example, a corrugated tube, a helically wound adhesive tape, a sheath formed to cover the plurality of wires 52 by extrusion molding, or a resin or metal tube.

A transverse section of the wiring member 50 may have any outer shape. In FIG. 3, the wiring member 50 has a transverse sectional shape in which the plurality of wires 52 are collected to contact each other. If the wiring member 50 is covered by a protective member, a transverse section of the wiring member 50 may have a circular outer shape. Note that the outer shape of the transverse section of the wiring member 50 may be an elliptical shape, a rectangular shape or the like. Note that a transverse section is a cross-section in a plane orthogonal to an axis of the wiring member 50.

The one end part of the wiring member 50 is connector-connected to the vehicle body-side device 18. The wiring member 50 may be directly pulled out from the vehicle body-side device 18. The one end part of the wiring member 50 may be connected to the vehicle body-side device 18 via another wiring member.

The other end part of the wiring member 50 may be connected to the wheel-side device 28 via a connector 51. The other end part of the wiring member 50 may be directly connected to the wheel-side device 28 without via any connector. In the other end part of the wiring member 50, the plurality of wires may be branched and respectively connected to different locations.

A part in the extension direction of the wiring member 50 is fixed in a rotation stopped state at a rotation stopping/fixing position P on the steering rotation center axis X.

Here, that the part in the extension direction of the wiring member 50 is fixed at the rotation stopping/fixing position P on the steering rotation center axis X means that the part in the extension direction of the wiring member 50 is supported at a fixed position or in a fixed region with respect to the steering rotation center axis X at the rotation stopping/fixing position P so that the steering rotation center axis X is held in such a positional relationship as to pass in a minimum inclusion circle C in the transverse section of the wiring member 50. Note that the minimum inclusion circle C is a minimum circle capable of including a part of the wiring member 50 appearing in the transverse section. For example, if the transverse sectional shape of the wiring member 50 is a collected shape of cross-sections of the plurality of wires 52, a minimum circle capable of including outer diameters of the cross-sections of the plurality of wires 52 is the minimum inclusion circle C. Further, the passage of the steering rotation center axis X through the inside of the minimum inclusion circle C includes a case where the steering rotation center axis X passes through a boundary line of the minimum inclusion circle C.

The steering rotation center axis X only has to pass through the inside of the minimum inclusion circle C. Accordingly, at the rotation stopping/fixing position P, the extension direction of the wiring member 50 and the steering rotation center axis X may be parallel or may obliquely intersect. At the rotation stopping/fixing position P, an angle of the extension direction of the wiring member 50 to the steering rotation center axis X may be within a range of ±30°, within a range of ±20°, within a range of ±10°, within a range of ±5° or within a range of ±1°.

In this embodiment, the part in the extension direction of the wiring member 50 is fixed by the fixing member 60. The fixing member 60 only has to be able to fix the part in the extension direction of the wiring member 50 in the above state and a configuration therefor is not particularly limited. The fixing member is preferably supported on a part not to be turned about the steering rotation center axis X by the turning of the wheel 20 about the steering rotation center axis X. For example, the fixing member 60 may be supported on at least one of the damper 37, the lower arm 32 and the upper arm 34.

Further, a state where the rotation of the part in the extension direction of the wiring member 50 is stopped at the rotation stopping/fixing position P on the steering rotation center axis X means a state where the rotation of the part in the extension direction of the wiring member 50 about the steering rotation center axis X is stopped at the rotation stopping/fixing position P. Thus, at the rotation stopping/fixing position P, the part in the extension direction of the wiring member 50 may swing about the axes, about which the lower arm 32 and the upper arm 34 swing. In this embodiment, the rotation of the part in the extension direction of the wiring member 50 about a center axis thereof is also stopped at the rotation stopping/fixing position P.

In this embodiment, the fixing member 60 includes a long portion 62 and a wiring fixing portion 64. A base end part of the long portion 62 is fixed to the lower arm 32 at a position different from the steering rotation center axis X by screwing, welding or the like. The long portion 62 extends upward from the lower arm 32 in parallel to the steering rotation center axis X. A tip part of the long portion 62 is located between the lower and upper arms 32, 34.

The wiring fixing portion 64 is a part for fixing the wiring member 50 in a rotation stopped state. For example, the wiring fixing portion 64 includes a base plate portion 64a and a push-in plate portion 64b. The base plate portion 64a extends in a direction intersecting (here, orthogonal to) an extension direction of the long portion 62 from the tip part of the long portion 62. For example, the long portion 62 and the base plate portion 64a may be a component formed by one metal plate. The wiring fixing portion 64 is separated upward from the lower arm 32 and separated downward from the upper arm 34.

A tip part of the base plate portion 64 reaches a position right lateral to the steering rotation center axis X. The push-in plate portion 64b includes a recess 64c capable of accommodating the wiring member 50. For example, the push-in plate portion 64b including the recess 64c may be formed by bending a metal plate.

Both end parts of the push-in plate portion 64b are fixed to the base plate portion 64a with the part in the extension direction of the wiring member 50 accommodated in the recess 64c. The push-in plate portion 64c may be fixed to the base plate portion 64a by screwing, welding, crimping or the like. With the both end parts of the push-in plate portion 64b fixed to the base plate portion 64a, an opening of the recess 64c is closed by the base plate portion 64a. In this state, the part in the extension direction of the wiring member 50 is sandwiched between the base plate portion 64a and the push-in plate portion 64b, whereby the rotation of the wiring member 50 is stopped. The steering rotation center axis X is set to pass through the recess 64c with the push-in plate portion 64b fixed to the base plate portion 64a. Thus, the part in the extension direction of the wiring member 50 fixed in the recess 64c is fixed in the rotation stopped state on the steering rotation center axis X.

That is, the fixing member 60 is supported at a position deviated from the steering rotation center axis X and reaches the steering rotation center axis X or the right vicinity of the steering rotation center axis X by detouring around the steering rotation center axis X. The part in the extension direction of the wiring member 50 is fixed in the rotation stopped state to a part of the fixing member 60 reaching the steering rotation center axis X or the right vicinity of the steering rotation center axis X.

The part in the extension direction of the wiring member 50 extends along the steering rotation center axis X at or near the part fixed by the fixing member 60. Each end part of the wiring member 50 is bent at a position separated from the wiring member 50 and extends toward the vehicle body-side device 18 or the wheel-side device 28, which is a connection destination thereof.

Since being supported on the lower arm 32, the fixing member 60 does not follow the turning of the wheel 20 about the steering rotation center axis X. Accordingly, the part in the extension direction of the wiring member 50 fixed by the fixing member 60 is fixed in the rotation stopped state on the steering rotation center axis X and does not turn about the steering rotation center axis X even if the wheel 20 turns about the steering rotation center axis X.

A configuration for fixing the wiring member 50 in the rotation stopped state is not limited to the above example. For example, the fixing member 60 may be a component including a resin part molded with the part in the extension direction of the wiring member 50 as an insert part. In this case, the resin part is held in close contact with the outer periphery of the part in the extension direction of the wiring member 50, whereby the rotation of the wiring member 50 is stopped. Further, for example, the fixing member may include a plastically deformable metal plate part, and this metal plate part may be crimped and fixed to the part in the extension direction of the wiring member 50. Further, for example, the part in the extension direction of the wiring member 50 may be tied and fixed to a member to be fixed and extending along the steering rotation center axis X by a binding member such as a zip tie.

The part in the extension direction of the wiring member 50 is fixed at an arbitrary position on the steering rotation center axis X. In this embodiment, the part in the extension direction of the wiring member 50 is fixed between the lower and upper arms 32, 34, i.e. between the upper and lower bearing portions 33, 35. The part in the extension direction of the wiring member 50 may be fixed at a position lower than the lower arm 32 (i.e. lower bearing portion) or may be fixed at a position above the upper arm 34 (i.e. upper bearing portion) on the steering rotation center axis X.

The wiring member 50 extends from the vehicle body-side device 18 in the vehicle body 10, is passed through the fender apron 16 and is introduced toward a side above the wiring fixing portion 64 of the fixing member 60. In accordance with a positional relationship of a pull-out location of the wiring member 50 from the vehicle body 10 and the wiring fixing portion 64 on the steering rotation center axis X, a part of the wiring member 50 closer to the vehicle body 10 than the fixed position is arranged in an appropriately bent state. Further, also when another member is interposed between the pull-out location of the wiring member 50 from the vehicle body 10 and the wiring fixing portion 64 on the steering rotation center axis X, a part of the wiring member 50 closer to the vehicle body 10 than the rotation stopping/fixing position P may be arranged in a bent state to avoid contact with the other member.

The part in the extension direction of the wiring member 50 is fixed in the rotation stopped state on the steering rotation center axis X by the wiring fixing portion 64. That is, an intermediate part in the extension direction of the wiring member 50 is fixed in the rotation stopped state on the steering rotation center axis X.

Further, the wiring member 50 is introduced toward a side below the wiring fixing portion 64, is bent outward in the vehicle width direction, extends toward the wheel-side device 28 and is connected to the wheel-side device 28 via the connector 51. A part of the wiring member 50 closer to the wheel 20 than the wiring fixing portion 64 is also appropriately bent to avoid interference with other components in accordance with the positional relationship of the wiring fixing portion 64 and the wheel-side device 28.

The operation of the suspension wiring module 40 including the wiring member 50 is described.

In FIG. 3, the wheel-side device 28 and the wiring member 50 extending toward the wheel-side device 28 when the vehicle body is held in a straight state are shown by solid lines, and the wheel-side device 28 and the wiring member 50 extending toward the wheel-side device 28 when the vehicle body turns left and when the vehicle body turns right are shown by two-dot chain lines. As shown in FIG. 3, if the wheel 20 turns about the steering rotation center axis X, the wheel-side device 28, which is the connection destination of the wiring member 50, turns about the steering rotation center axis X. Thus, a positional relationship of the rotation stopping/fixing position P on the steering rotation center axis X and the wheel-side device 28 is kept as constant as possible. Since the wiring member 50 is connected to the wheel-side device 28 by way of the rotation stopping/fixing position P on the steering rotation center axis X, even if the wheel 20 turns about the steering rotation center axis X, a part of the wiring member 50 from the rotation stopping/fixing position P to the wheel-side device 28 is kept in a constantly bent state as much as possible. Thus, when the wheel 20 is turned by a steering operation, a force for bending or linearly extending the wiring member 50 hardly acts and the bending deformation of the wiring member 50 is suppressed.

Further, since the rotation of the part in the extension direction of the wiring member 50 is stopped at the rotation stopping/fixing position P, if the wheel 20 is turned by the steering operation, a part of the wiring member 50 between the part fixed at the rotation stopping/fixing position P and the wheel-side device 28 is thought to be twisted and deformed. For example, a part of the wiring member 50 along the steering rotation center axis X near the rotation stopping/fixing position P is thought to be easily twisted and deformed.

That is, the turning of the wheel 20 about the steering rotation center axis X by a steering operation can be dealt with by not the bending deformation, but the torsional deformation of the wiring member 50.

Since the torsional deformation of the wiring member 50 by the steering operation is stopped at the rotation stopping/fixing position P, it is not transmitted to the vehicle body 10 further beyond the rotation stopping/fixing position P. Thus, even during the steering operation, the part of the wiring member 50 closer to the vehicle body 10 than the rotation stopping/fixing position P is hardly twisted and deformed.

If the lower and upper arms 32, 34 swing due to an uneven road surface or the like, the fixing member 60 supported on the lower arm 32 also swings. Thus, the rotation stopping/fixing position P is displaced to swing with respect to the vehicle body 10. In this way, the part of the wiring member 50 between the vehicle body 10 and the rotation stopping/fixing position P is thought to swing and be bent and deformed. Since the torsional deformation is hardly transmitted from the rotation stopping/fixing position P toward the vehicle body 10 as described above, the part of the wiring member 50 between the vehicle body 10 and the rotation stopping/fixing position P is hardly twisted and deformed due to the steering operation and mainly bent and deformed due to a vertical movement of the vehicle body 10.

Thus, the part of the wiring member 50 closer to the wheel-side device 28 than the rotation stopping/fixing position P is mainly twisted and deformed due to the turning of the wheel 20 about the steering rotation center axis X, and the part of the wiring member 50 closer to the vehicle body-side device 18 than the rotation stopping/fixing position P is mainly bent and deformed due to a vertical movement of the wheel 20.

According to the suspension wiring module 40 thus configured, the deformation of the wiring member 50 due to the steering operation mainly occurs in the wheel-side device 28 rather than at the rotation stopping/fixing position P and hardly occurs on the side closer to the vehicle body-side device 18 than the rotation stopping/fixing position P. The deformation of the wiring member 50 due to the vertical movement of the wheel 20 mainly occurs on the side closer to the vehicle body-side device 18 than the rotation stopping/fixing position P and hardly occurs on the side closer to the wheel-side device 28 than the rotation stopping/fixing position P. Thus, the wiring member 50 is hardly complexly deformed and the deformation behavior of the wiring member 50 is simplified with the rotation stopping/fixing position P as a boundary. In this way, the durability of the wiring member 50 is expected to improve. Further, the behavior of the wiring member 50 is easily grasped and measures are easily taken for durability improvement.

Further, since the bending deformation of the wiring member 50 is suppressed on the side closer to the wheel 20 than the rotation stopping/fixing position P, it is no longer necessary to secure a space taking into account the bending deformation of the wiring member 50 near the wheel 20. In this way, a space for routing the wiring member near the wheel 20 can be made as small as possible.

Further, since the bending deformation of the wiring member 50 is suppressed near the wheel 20, the wiring member 50 is hardly bent and deformed to contact peripheral members of the wheel 20 and a location where a protective member for the wiring member 50 is provided can be reduced. In this way, the wiring member 50 can be reduced in size near the wheel 20.

Further, since the bending deformation of the wiring member 50 is suppressed near the wheel 20, fixing locations of the wiring member 50 near the wheel 20 can be reduced. In this way, the wiring member 50 is easily routed and a design for securing the fixing locations is facilitated.

Further, the damper 37 is located at a position deviated in a horizontal direction from the steering rotation center axis X, and the wiring member 50 is fixed at the rotation stopping/fixing position P present at a position different from the extension Q of the damper 37. Thus, the behavior of the wiring member 50 can be simplified in a configuration in which the extension Q of the damper 37 and the steering rotation center axis X are different.

Further, if the wiring member 50 is fixed by the fixing member fixed to at least one of the damper 37, the lower arm 32 and the upper arm 34 at the rotation stopping/fixing position P, the wiring member 50 is easily fixed with rotation about the steering rotation center axis X stopped.

### Modifications

Various modifications are described.

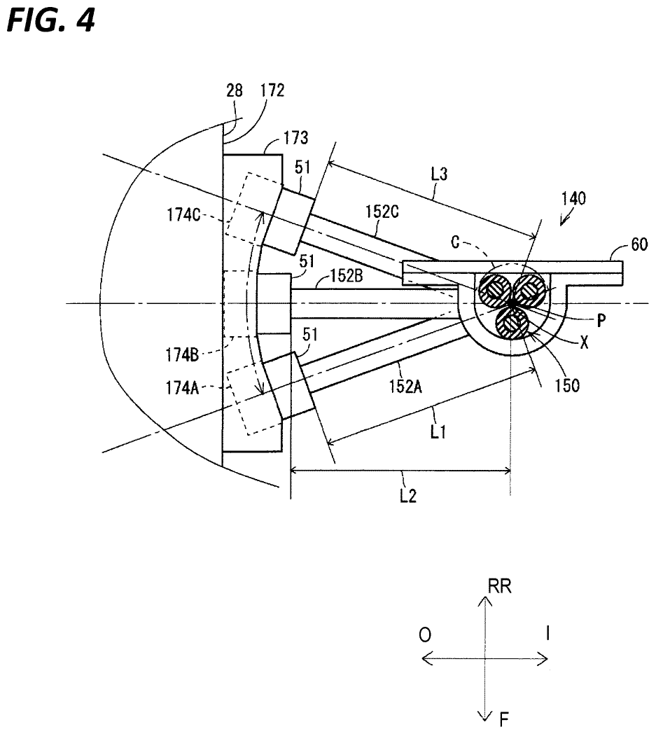

FIG. 4 is a diagram showing a suspension wiring module 140 according to a first modification. In the suspension wiring module 140 according to the first modification, a wiring member 150 corresponding to the wiring member 50 includes a wire 152A serving as a first linear transmission member, a wire 152B serving as a second linear transmission member and a wire 152C serving as a third linear transmission member.

When L1 denotes a length of the wire 152A from the rotation stopping/fixing position P to the wheel-side device 28, L2 denotes a length of the wire 152B from the rotation stopping/fixing position P to the wheel-side device 28 and L2 denotes a length of the wire 152C from the rotation stopping/fixing position P to the wheel-side device 28, the lengths L1, L2 and L3 are set to be equal. A case where the lengths L1, L2 and L3 are equal includes a case where the lengths L1, L2 and L3 are equal within a manufacturing tolerance range. For example, the case where the lengths L1, L2 and L3 are equal includes a case where actually measured lengths L1, L2 and L3 differ in a range of +5%.

Here, a reference position at the rotation stopping/fixing position P may be based on a fixing point where each of the wires 152A, 152B and 152C is fixed at a position closest to the wheel-side device 28 by the fixing member 60. Further, the reference position in the wheel-side device 28 may be, for example, a position where the wires 152A, 152B and 152C reach connectors 51. In the absence of the connectors 51, the reference position in the wheel-side device 28 may be, for example, a position where the wires 152A, 152B and 152C are introduced into the wheel-side device 28.

The above lengths L1, L2 and L3 are not lengths in a plane orthogonal to the steering rotation center axis X, but lengths in a three-dimensional space of the wires 152A, 152B and 152C. Thus, if the wires 152A, 152B and 152C have parts along the steering rotation center axis X, parts oblique to the steering rotation center axis X or curved parts between the rotation stopping/fixing position P and the wheel-side device 28, the lengths L1, L2 and L3 are lengths taking into account those actual path lengths.

In this embodiment, the wires 152A, 152B and 152C are bent and extend toward the wheel-side device 28 after extending downward along the steering rotation center axis X from the rotation stopping/fixing position P (see FIG. 1).

The wheel-side device 28 is provided with a device body 172 and a plurality of (here, three) connectors 174A, 174B and 174C. Each of the plurality of connectors 174A, 174B and 174C keeps the wire 152A, 152B, 152C in such a posture that the wire 152A, 152B, 152C is pulled toward the steering rotation center axis X from the device body 172. The plurality of connectors 174A, 174B and 174C respectively keep the wires 152A, 152B and 152C in the above posture at different positions about the steering rotation center axis X. Here, that the connector 174A, 174B, 174C keeps the wire 152A, 152B, 152C in such a posture that the wire 152A, 152B, 152C is pulled toward the steering rotation center axis X from the device body 172 means, for example, that, if a part of the wire 152A, 152B, 152C pulled out from the connector 174A, 174B, 174C is extended, this extended part passes through the steering rotation center axis X.

Here, the plurality of connectors 174A, 174B and 174C are provided in the device body 172 in postures facing the steering rotation center axis X. Here, that the connector 174A, 174B, 174C faces the steering rotation center axis X means, for example, that, assuming the connector 174A, 174B, 174C as a starting region (preferably, assuming a widthwise central part of the connector 174A, 174B, 174C as a starting region), a virtual extension region in a connection direction of the connector 51 to the connector 174A, 174B, 174C passes through the steering rotation center axis X and a part of the connector 174A, 174B, 174C on a ide to be connected to the connector 51 is in the posture facing the steering rotation center axis X.

The connection direction of the connector 51 to the connector 174A, 174B, 174C coincides with a facing direction of the connector 174A, 174B, 174C toward the steering rotation center axis X. Further, an extension direction of the wire 152A, 152B, 152C from the connector 51 is opposite to the connection direction of the connector 51 to the connector 174A, 174B, 174C. Thus, if the connector 51 is connected to the connector 174A, 174B, 174C, the wire 152A, 152B, 152C extending from a back part of this connector 51 is pulled to face the steering rotation center axis X in accordance with the facing direction of the connector 174A, 174B, 174C.

Here, a base portion 173 is provided in an inner part in the vehicle width direction of the device body 172. An inner part in the vehicle width direction of the base portion 173 is gradually recessed from both outer parts in a width direction thereof (front-rear direction on the basis of the vehicle body) toward a widthwise central part thereof.

With the wheel 20 located at a neutral position (state where the vehicle travels straight), the base portion 173 is provided on an outer side in the vehicle width direction with respect to the steering rotation center axis X. Out of the three connectors 174A, 174B and 174C, one connector 174B is provided in the widthwise central part of the base portion 173 and facing inward toward the steering rotation center axis X along the vehicle width direction. The other two connectors 174A, 174C are provided on both widthwise end sides of the base portion 173. Since one end part in the width direction (front part in the vehicle front-rear direction) of the base portion 173 is facing obliquely rearward with respect to an inward direction along the vehicle width direction, the connector 174A provided in this part is facing obliquely rearward toward the steering rotation center axis X with respect to the inward direction along the vehicle width direction. Since the other end part in the width direction (rear part in the vehicle front-rear direction) of the base portion 173 is facing obliquely forward with respect to the inward direction along the vehicle width direction, the connector 174C provided in this part is facing obliquely forward toward the steering rotation center axis X with respect to the inward direction along the vehicle width direction. The plurality of connectors 174A, 174B and 174C may be connectors each including a recess, to which the connector 51 is connected, and may be provided to face the steering rotation center axis X in a state embedded in the device body 172. The plurality of connectors 174A, 174B and 174C may project from the device body 172 or the base portion 173. Note that the three connectors 174A, 174B and 174C may be integrated by the base portion 173 as described above or may be separately provided in the device body.

If a plane orthogonal to the steering rotation center axis X is observed, the plurality of wires 152A, 152B and 152C respectively radially extend from the steering rotation center axis X toward the corresponding connectors 174A, 174B and 174C, and the connectors 51 on the respective ends extend toward the corresponding connectors 174A, 174B and 174C. That is, the wire 152B linearly extends from the steering rotation center axis X toward the outer side in the vehicle width direction and is connected to the middle connector 174B. The wire 152C linearly extends obliquely rearward from the steering rotation center axis X toward the outer side in the vehicle width direction and is connected to the connector 174C on the rear side in the front-rear direction of the vehicle body 10. The wire 152A linearly extends obliquely forward from the steering rotation center axis X toward the outer side in the vehicle width direction and is connected to the connector 174A on the front side in the front-rear direction of the vehicle body 10. That is, the three wires 152A, 152B and 152C radially and linearly extend from the steering rotation center axis X as a center in the plane orthogonal to the steering rotation center axis X.

The plurality of connectors 174A, 174B and 174C may be provided in the device body 172 to be arranged along an arc having the steering rotation center axis X as a curvature center. In other words, when viewed along the steering rotation center axis X, the plurality of connectors 174A, 174B and 174C may be provided at positions equidistant from the steering rotation center axis X.

If extension distances of the respective wires 152A, 152B and 152C from the rotation stopping/fixing position P are equal and bent positions thereof toward the wheel-side device 28 are aligned in the direction of the steering rotation center axis X, the above lengths L1, L2 and L3 can be equal.

According to this modification, the wires 152A, 152B and 152C are expected to exhibit the same behavior between the rotation stopping/fixing position P and the wheel-side device 28. For example, the torsionally deformed states of the wires 152A, 152B and 152C by the steering operation can be aligned. In this way, the durability of the respective wires 152A, 152B and 152C can be aligned.

In this modification, the wires 152A, 152B and 152C are assumed to be power supply wires for supplying a three-phase alternating current. In the case of supplying a direct current to the wheel-side device 28, the wiring member 150 is assumed to include two wires for power supply. In this case, these two wires may have the same length between the rotation stopping/fixing position P and the wheel-side device 28.

Further, besides the plurality of wires set to have the same length between the rotation stopping/fixing position P and the wheel-side device 28, another wire having a length different from those wires may be provided in the suspension wiring module 140 according to this modification. For example, a wire for signal thinner than the wires 152A, 152B and 152C may be provided.

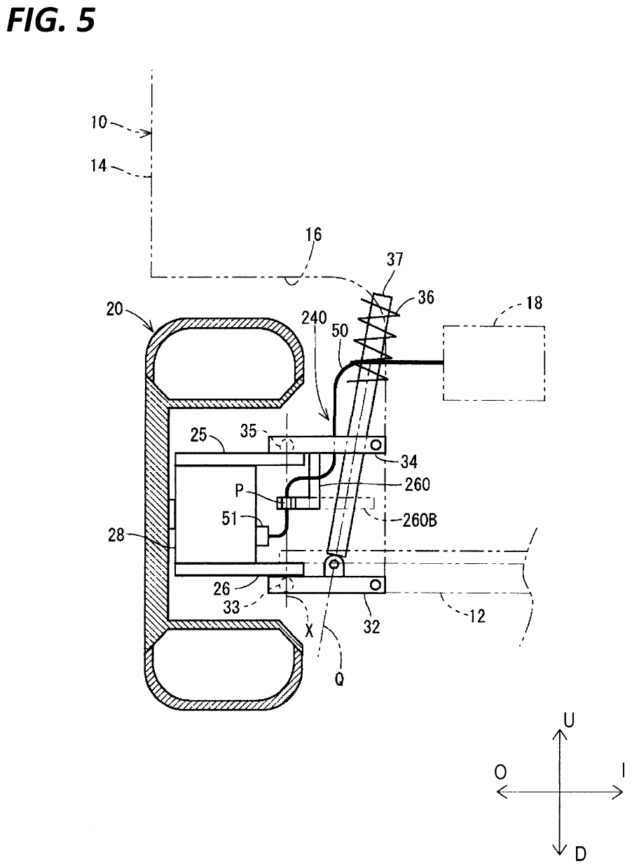

FIG. 5 is a diagram showing a suspension wiring module 240 according to a second modification. As shown in FIG. 5, a fixing member 260 corresponding to the fixing member 60 may be supported by the upper arm 34. The fixing member 260 is supported in a state hanging from the upper arm 34. A part in the extension direction of the wiring member 50 is fixed to a tip part of the fixing member 260 in a rotation stopped state at the rotation stopping/fixing position P on the steering rotation center axis X.

Like a fixing member 260B shown by two-dot chain line of FIG. 5, a base end part of the fixing member 260B may be supported by the damper 37. In this case, the fixing member 260B extends from the damper 37 toward the outer side in the vehicle width direction. A part in the extension direction of the wiring member 50 is fixed to a tip part of the fixing member 260B in a rotation stopped state at the rotation stopping/fixing position P on the steering rotation center axis X.

Note that the suspension wiring module may be fixed at a plurality of rotation stopping/fixing positions P. For example, the above embodiment and the second modification may be combined, and the part in the extension direction of the wiring member 50 may be fixed in the rotation stopped state at two rotation stopping/fixing positions P by the fixing members 60, 260B.

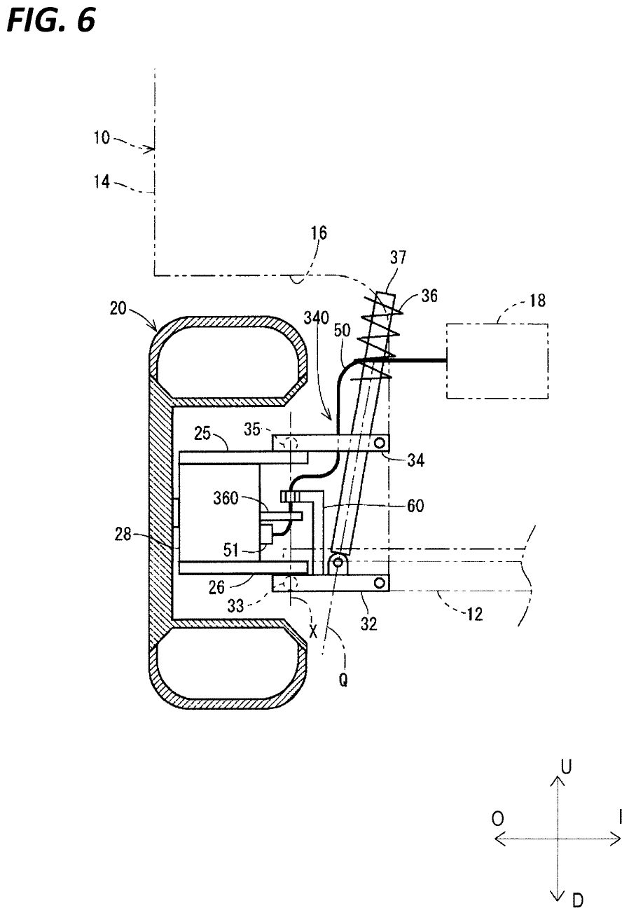

FIG. 6 is a diagram showing a suspension wiring module 340 according to a third modification. As shown in FIG. 6, an additional fixing member 360 may fix another part in the extension direction of the wiring member 50 in addition to the fixing member 60.

The additional fixing member 360 may fix the other part in the extension direction of the wiring member 50 in the rotation stopped state or in a rotation allowing state on the steering rotation center axis X.

For example, the additional fixing member 360 extends from the wheel-side device 28 toward the steering rotation center axis X and fixes the other part in the extension direction of the wiring member 50 on the steering rotation center axis X. The additional fixing member 360 may be supported by the lower knuckle portion 26 or the upper knuckle portion 25.

The other part in the extension direction of the wiring member 50 may be fixed at a tip part of the additional fixing member 360 with rotation with respect to the additional fixing member 36 stopped. In this case, the wheel 20 and the additional fixing member 360 turn about the steering rotation center axis X by a steering operation. Thus, the other part in the extension direction of the wiring member 50 turns about the steering rotation center axis X by the steering operation while being located on the steering rotation center axis X. In this point, the additional fixing member 360 differs from the fixing member 60.

The other part in the extension direction of the wiring member 50 may be loosely inserted and held through the tip part of the additional fixing member 360, and the part in the extension direction of the wiring member 50 may be allowed to rotate with respect to the additional fixing member 360.

The additional fixing member may be supported on at least one of the lower arm 32, the upper arm 34 and the damper 37, and support the part in the extension direction of the wiring member 50 in a rotation allowing state.

Further, a member for supporting another part in the extension direction of the wiring member 50 may be added at a position separated from the steering rotation center axis X.

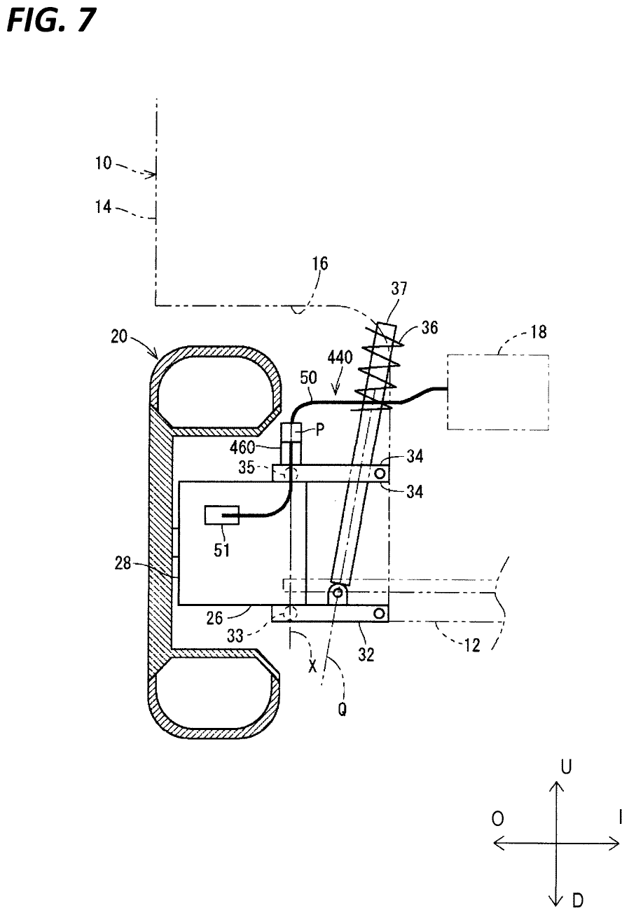

FIG. 7 is a diagram showing a suspension wiring module 440 according to a fourth modification. In FIG. 7, a fixing member 460 is used instead of the fixing member 60. The fixing member 460 projects further upward than the upper arm 34, and fixes a part in the extension direction of the wiring member 50 in a rotation stopped state on the steering rotation center axis X at the rotation stopping/fixing position P present above the upper arm 34. As just described, the rotation stopping/fixing position P may not be present between the lower and upper arms 32, 34 (i.e. between the upper and lower bearing portions).

Note that the knuckle portions 25, 26 are omitted in FIG. 7 and a component inside the wheel 20 (casing of the wheel-side device 28) and the like are rotatably supported on tip parts of the arms 32, 34 via the bearing portions. Further, the connector 51 is connector-connected to a front part of the wheel-side device 28. The rotation stopping/fixing position P may be provided at a position below the lower arm 32.

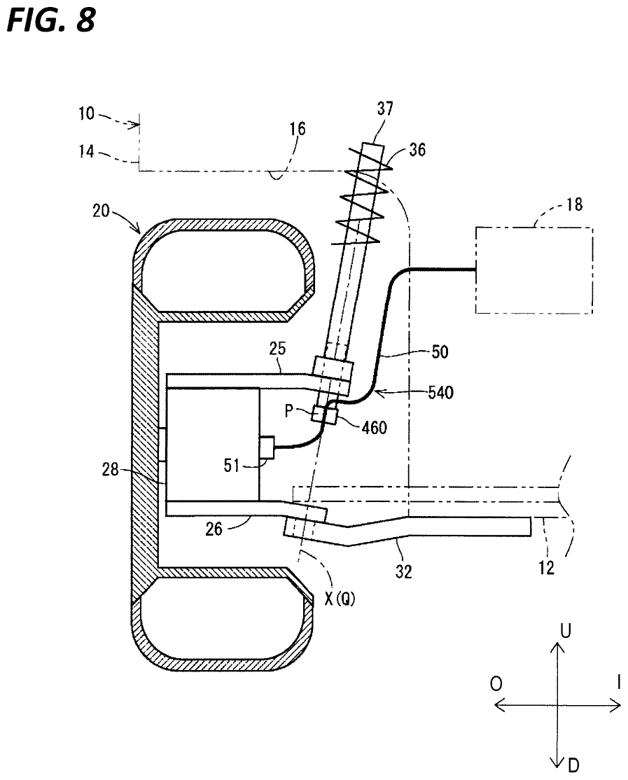

FIG. 8 is a diagram showing a suspension wiring module 540 according to a fifth modification. In FIG. 8, the upper arm 34 is omitted and the lower end part of the damper 37 is coupled to an upper part of the bearing portion of the upper knuckle portion 25. That is, FIG. 8 shows an example of not a double wishbone type suspension, but a strut type suspension. In this example, the extension Q of the damper 37 and the steering rotation center axis X coincide.

In this example, a fixing member 460 corresponding to the fixing member 60 is provided to hang down from the lower end part of the damper 37 through around the upper knuckle portion 25. A part in the extension direction of the wiring member 50 is fixed in a rotation stopped state to a lower end part of the fixing member 460 on the steering rotation center axis X.

Also in this modification, the deformation of the wiring member 50 due to a steering operation mainly occurs in the wheel-side device 28 rather than at the rotation stopping/fixing position P and hardly occurs on the side closer to the vehicle body-side device 18 than the rotation stopping/fixing position P. Further, the deformation of the wiring member 50 due to a vertical movement of the wheel 20 mainly occurs on the side closer to the vehicle body-side device 18 than the rotation stopping/fixing position P and hardly occurs on the side closer to the wheel-side device 28 than the rotation stopping/fixing position P. Thus, a section in which the deformation due to the steering rotation occurs and a section in which the deformation due to a vertical movement occurs can be separated on a path of the wiring member 50 with the rotation stopping/fixing position P as a boundary and the behavior of the suspension wiring member 50 can be simplified.

Note that the respective configurations described in the above embodiment and the respective modifications can be combined as appropriate without contradicting each other.

### LIST OF REFERENCE NUMERALS

10 vehicle body
12 floor part
14 body part
16 fender apron
18 vehicle body-side device
19 steering wheel
19a steering shaft
19b transmission mechanism
20 wheel
22 disk wheel
22a disk portion
22b tire mounting portion
24 tire
25 upper knuckle portion
26 lower knuckle portion
26a arm portion
28 wheel-side device
28a shaft
32 lower arm
33, 35 bearing portion
34 upper arm
36 spring
37 damper
38 tie rod
40, 140, 240, 340, 440, 540 suspension wiring module
50, 150 wiring member
51 connector
52, 152A, 152B, 152C wire
52a core wire
52b coating
60, 260, 260B, 460 fixing member
62 long portion
64 wiring fixing portion
64a base plate portion
64b push-in plate portion
64c recess
140 suspension wiring module
172 device body
173 base portion
174A, 174B, 174C connector
360 additional fixing member
C minimum inclusion circle
P rotation stopping/fixing position
Q extension of damper
X steering rotation center axis

1. A suspension wiring module, comprising:
a wiring member for connecting a vehicle body-side device and a wheel-side device,
a part in an extension direction of the wiring member being fixed with rotation about a steering rotation center axis stopped at a rotation stopping/fixing position on the steering rotation center axis.

2. The suspension wiring module of claim 1, wherein the wiring member is fixed at a position different from an extension of a damper.

3. A suspension wiring module, comprising:
a wiring member for connecting a vehicle body-side device and a wheel-side device,
a part in an extension direction of the wiring member being fixed in a rotation stopped state at a rotation stopping/fixing position on a steering rotation center axis,
the wiring member including a first linear transmission member and a second linear transmission member,
end parts of the respective first and second linear transmission members on side of the wheel-side device being connected to a connector at mutually different positions, and
a length of the first linear transmission member from the rotation stopping/fixing position to the wheel-side device being equal to a length of the second linear transmission member from the rotation stopping/fixing position to the wheel-side device.

4. The suspension wiring module of claim 1, wherein the wiring member is fixed by a fixing member fixed to at least one of a damper, an upper arm and a lower arm at the rotation stopping/fixing position.

5. The suspension wiring module of claim 1, wherein the wiring member is so fixed at the rotation stopping/fixing position that an angle of the extension direction of the wiring member to the steering rotation center axis is within a range of ±30°.
